(19) United States
(12) Patent Application Publication
(10) Pub. No.: US 2012/0065922 A1
(43) Pub. Date: Mar. 15, 2012

(54) SIMULATING AN UMBILICAL

(76) Inventor: Silviu Puchianu, Nailsea (GB)

(21) Appl. No.: 13/230,119

(22) Filed: Sep. 12, 2011

(30) Foreign Application Priority Data
Sep. 13, 2010 (EP) 10176447.0
Aug. 26, 2011 (EP) 11179041.6

(51) Int. Cl. G06F 19/00; G06G 7/48

(52) U.S. Cl. 702/123; 703/10

(57) ABSTRACT

A method of simulating an umbilical for use with a subsea fluid extraction well is provided. The method comprises using a programmed processing unit to condition an input electrical signal for producing an output signal characteristic of a signal which has passed through such an umbilical.

### BACKGROUND OF THE INVENTION

1. Field of the Invention

The field of the invention relates to a method of simulating an umbilical for use with a subsea fluid extraction well, a method of testing control equipment for a subsea fluid extraction well and apparatus for simulating an umbilical for use with a subsea fluid extraction well.

2. Description of the Prior Art

With a subsea fluid extraction well, such as a hydrocarbon extraction well, an umbilical, which can be up to several tens of kilometres in length, is used to transfer communications for control and monitoring, electrical power, hydraulics and chemicals between an above-surface well control station and subsea control equipment, located on the subsea, which is used to control well operation. The type and complexity of an umbilical depends on the number of wells being controlled and the scope of supply of the subsea control equipment. Umbilicals are therefore designed specifically for each application. Due to the length and characteristics of an umbilical, it can cause detrimental effects to the signals and power being transmitted through it, such as loss of power, attenuation of signals and reflections which can cause overvoltages, etc. These aspects have to be taken into consideration in the design of the overall system.

When the subsea control equipment is brought together and assembled in its system configuration for testing prior to installation, such as at the factory or at a system test facility, there is a need to simulate the umbilical in order to provide the signal and power characteristics expected at its termination when testing, because it is impracticable to utilize the actual umbilical itself.

The main electrical aspects of subsea control equipment which need testing are the electrical aspects, which include the control and distribution of electrical power to the various equipments which are to be installed on the seabed and the communication between surface equipment and subsea equipment. The method of communication usually employed is known as communications-on-power (COP), where the communication signals are superimposed on the electrical power supply. Any electrical effects caused by the use of a long umbilical due to its particular electrical characteristics need to be simulated to ensure that the electrical power applied to the subsea control equipment in its test configuration is the same as that when installed and operational on the seabed and the method and characteristics of the communications (for example, COP) are the same.

At present, the method of testing adopted is to use a hardware representation of the umbilical in the form of specially designed electrical circuitry (an arrangement of passive components) which is connected between the main electrical supply and the subsea control equipment under test. A new umbilical simulator has to be designed and built for each test configuration, which is expensive and time consuming.

### BRIEF SUMMARY OF THE INVENTION

According to embodiment of the present invention, there is provided a method of simulating an umbilical for use with a subsea fluid extraction well, the method comprising using a programmed processing unit to condition an input electrical signal for producing an output signal characteristic of a signal which has passed through such an umbilical,

According to another embodiment of the present invention, there is provided a method of testing control equipment for a subsea fluid extraction well, the method comprising simulating an umbilical using a programmed processing unit to condition an input electrical signal for producing an output signal characteristic of a signal which has passed through such an umbilical and supplying that output signal to the control equipment.

According to yet another embodiment of the present invention, there is provided an apparatus for simulating an umbilical for use with a subsea fluid extraction well, the apparatus comprising a processing unit which is programmable or has been programmed for conditioning an input electrical signal for producing an output signal characteristic of a signal which has passed through such an umbilical.

### BRIEF DESCRIPTION OF THE DRAWINGS

FIG. 1 is a schematic diagram of a typical subsea fluid extraction well control system;

FIG. 2 is a schematic diagram of a simulator according to an embodiment of the present invention; and

FIG. 3 is a schematic diagram of components of the simulator according to an embodiment of the present invention.

### DETAILED DESCRIPTION OF THE INVENTION

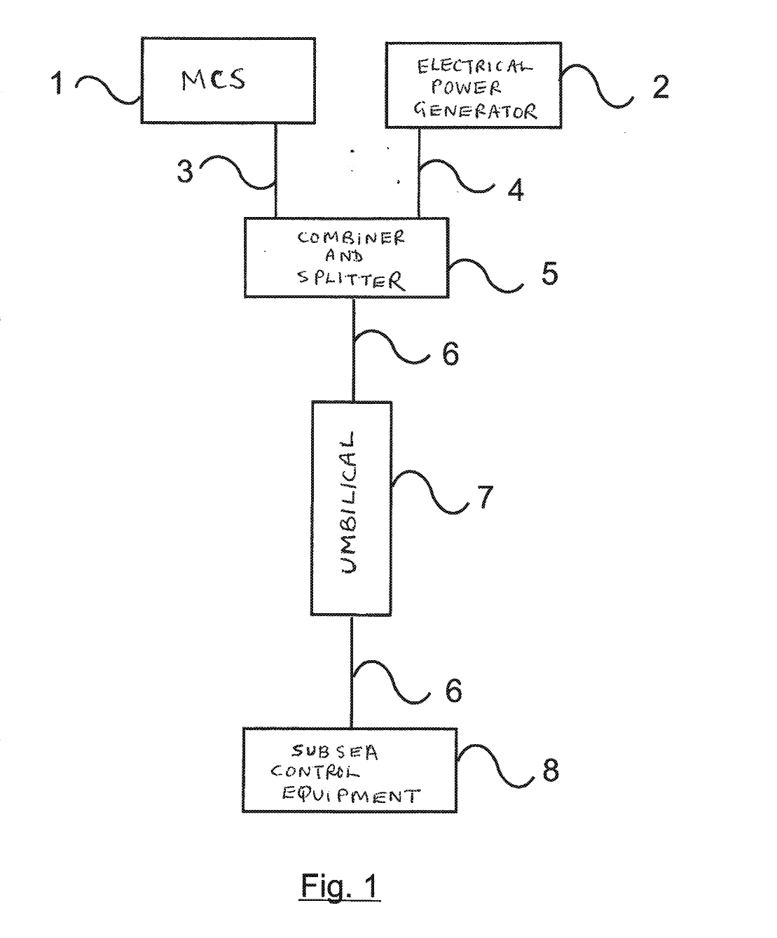

The configuration of a typical subsea fluid extraction well control system is shown in FIG. 1. A master control station (MCS) 1, situated on a floating platform or rig, enables an operator to control the operation of an offshore well. An electrical power generator 2, which is usually co-located with the station 1, provides all the electrical power supply required by subsea control equipment 8 which is positioned on the subsea. The electrical power supply on a line 4 is passed to combiner and splitter equipment 5, where communication signals on line 3 from the master control station (i.e. control signals to the subsea control equipment) are combined with the electrical power supply. The combined electrical power and communication signals on a line 6 are then transmitted via an umbilical 7 to the subsea control equipment 8. Also, return sensor signals from the subsea control equipment on line 6 are split off by the splitter 5 and received by station 1 via line 3.

The umbilical 7 exhibits the characteristics of an electrical transmission line at both the operating frequency of the electrical power supply and that of the communications, such as signal attenuation, loss of power along its length and reflections due to load mismatch.

Such characteristics of the umbilical may be determined either theoretically, or from practical experience. In particular, the physical dimensions and quantities of copper to be used are known, and hence the impedance per unit length of the umbilical, for various frequencies, may also be determined. In addition, experienced well operators also have data on how signals of various frequencies are affected by umbilicals of various dimensions.

The programmable umbilical simulator to be described is a single device that can be programmed to simulate the electrical behaviour of any umbilical, and can be used for any subsea system and is intended to replace the present variety of umbilical simulators with a single programmable one.

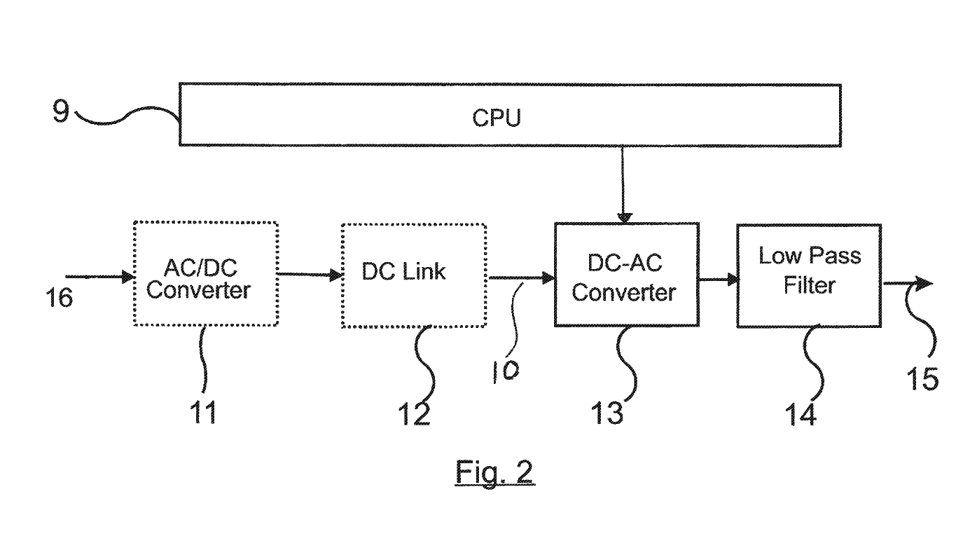

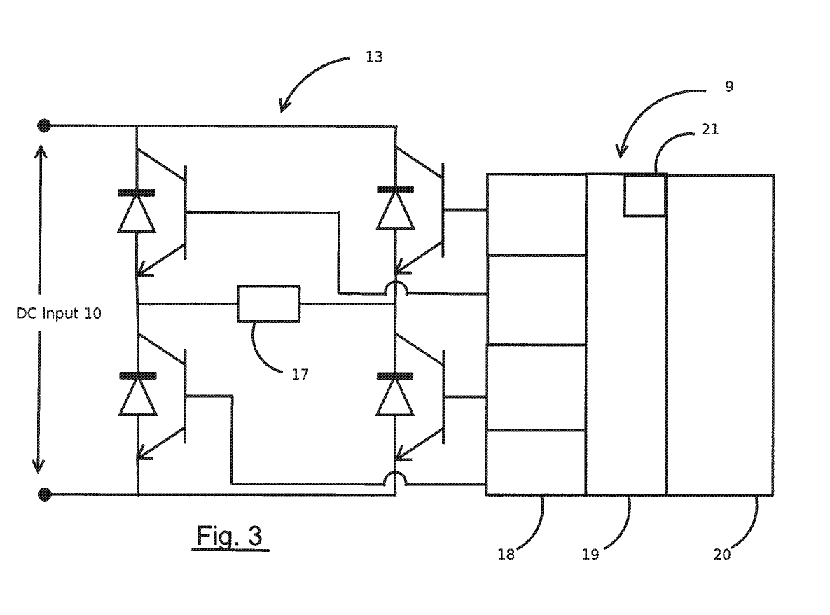

The configuration of the programmable umbilical simulator is shown in FIG. 2. The apparatus comprises a programmable central processing unit (CPU) 9 coupled to a DC to AC converter (i.e. an inverter) 13 which receives an input DC electrical signal at an input 10. FIG. 3 shows these two components in greater detail. The converter 13 (in the form of a so-called H-bridge shown in more detail in FIG. 3 and described in more depth below) converts the DC to AC using digitally controlled pulse width modulation (PWM) techniques to produce a power waveform which is acted on by CPU 9. More particularly, the CPU 9 has been programmed so that it distorts the waveform produced by converter 13 so that appropriate harmonic content is added to the power waveform so that the output from converter 13 is a simulation of the output of a particular umbilical. If it is desired that the simulation is one of a COP signal from the umbilical, the CPU 9 is programmed so that suitable information is also added to or imprinted on the power waveform to achieve that. A signal input 16 is provided for receiving an input signal, for example a “pure” sinusoidal waveform.

The above simulator would be used at a test facility for testing subsea control equipment, the output from converter 13 being supplied to the equipment to be tested via an output 15, if necessary via an optional low pass filter 14.

If only AC electrical power is available at the test facility, the simulator may include an AC/DC converter 11 and a DC link 12 between input 16 and input 10 to provide the DC input power required by the DC-AC converter 13.

In either case, the simulator may be provided as a piece of hardware, with an input 16, output 15, and means, for example a human interaction interface such as a keyboard, monitor etc (not shown), for instructing the CPU 9 to provide the desired simulation. Alternatively, the simulator may be connected to separate computing means, for example via universal serial bus (USB) connection or the like.

FIG. 3 shows the CPU 9 and DC-AC converter 13 in more detail. The converter 13 comprises a standard H-bridge, with a switch on each arm of the “H” comprising a transistor and operable on DC input 10. For convenience, the output from converter 13 is shown as a simple load 17. Each switch is driven by a driver 18 of the CPU 9, the drivers 18 being controlled by processing means 19. Processing means 19 is operable to obtain information from a database 20, which stores look-up tables containing frequency-dependent pulse width modulation (PWM) timings. A read/write unit 21 is provided enabling operators to interact with the CPU 9, for example to update or modify the information stored in database 20, or to input the desired umbilical physical characteristics. This may comprise human-interface means as described above, or may enable connection to an external computing means.

For the purposes of illustration, the following description of the simulator operation will be described where a standard COP system using an AC input for a subsea installation is required to be tested.

Initially, the database 20 of CPU 9 is loaded with look-up tables providing PWM timings for a set of possible umbilical physical characteristics. Since the umbilical will affect different frequency signals in different ways, the look-up tables are frequency-dependent. This step will typically be carried out once only, during initial set-up of the simulator, unless, for example, errors are found at a later stage. The look-up tables are concatenated, so that a single PWM timing sequence may be derived for the frequencies of interest, i.e. the COP frequencies.

The subsea equipment to be tested is connected to output 15 of the simulator, and a signal source is connected to AC input 16, the source being equivalent to that which would be supplied in use of the subsea equipment. Generally, the signal source will be relatively “pure”, i.e. a superposition of sinusoidal signals of various frequencies with little distortion, although since with the COP system there is a relatively complex superposition of frequencies, i.e. a number of different frequency inputs are used, the input may not appear particularly pure.

The characteristics of the umbilical to be used are entered into CPU 9 via unit 21, and the processing means 19 selects the corresponding look-up tables in database 20 and retrieves the relevant PWM switch timings. Processing means 19 then controls drivers 18 to operate each switch of the converter 13 at the correct PWM switch timing.

The AC input is converted to DC by AC/DC converter 11, and passed via link 12 to input 10 of converter 13.

The converter 13 then converts the input DC signal 10 to AC, however harmonics will be introduced into that AC signal by virtue of the switch timings used by the converter 13. In other words, the signal will become distorted, in a similar manner as would occur using an umbilical of the physical characteristics specified.

The AC output from the converter 13 is passed through a low pass filter 14 if required, and then output via output 15 to the test equipment.

Embodiments of the present invention enable the design of a novel generic or universal programmable umbilical simulator which can be easily adapted for use in testing all subsea control equipment. This is achieved by including a programmable processing unit in a simulator so that only the software need be adapted to change the characteristics of the simulator as required.

Embodiments of the present invention allow for more comprehensive testing of systems to be carried out as a programmable simulator enables a wider range of umbilical characteristics and different system possibilities to be simulated for a single test configuration.

Having to design, develop, and build an umbilical simulator for each subsea control equipment to be tested is time consuming, uses manpower and is expensive. The use of a generic simulator will significantly reduce these costs. This is because the changes required are limited to the software content, the hardware design requiring no modifications.

The programmable umbilical simulator is a product in its own right as it can be supplied as a test tool forming part of the test equipment supplied to a customer for testing and maintenance or as a separate product.

What is claimed is:

1. A method of simulating an umbilical for use with a subsea fluid extraction well, the method comprising using a programmed processing unit to condition an input electrical signal for producing an output signal characteristic of a signal which has passed through such an umbilical.

2. The method according to claim 1, wherein the input electrical signal is DC and the DC input electrical signal is conditioned by a DC-AC converter.

3. The method according to claim 2, wherein the converter conditions the input electrical signal using pulse width modulation.

4. The method according to claim 2, wherein the DC-AC converter comprises an H-bridge.

5. The method according to claim 4, wherein the H-bridge comprises a plurality of switches, the operation timings of the switches being controlled by the programmed processing unit to effect the conditioning.

6. The method according to claim 5, wherein the switch timings are selected by the processing unit from a look-up table.

7. The method of testing control equipment for a subsea fluid extraction well, the method comprising simulating an umbilical using a programmed processing unit to condition an input electrical signal for producing an output signal characteristic of a signal which has passed through such an umbilical and supplying that output signal to the control equipment.

8. The method according to claim 7, wherein the input electrical signal is DC, and the DC input electrical signal is conditioned by a DC-AC converter.

9. The method according to claim 8, wherein the converter conditions the input electrical signal using pulse width modulation.

10. The method according to claim 8, wherein the DC-AC converter comprises an H-bridge.

11. The method according to claim 10, wherein the H-bridge comprises a plurality of switches, the operation timings of the switches being controlled by the programmed processing unit to effect the conditioning.

12. The method according to claim 11, wherein the switch timings are selected by the processing unit from a look-up table.

13. An apparatus for simulating an umbilical for use with a subsea fluid extraction well, the apparatus comprising a processing unit which is programmable or has been programmed for conditioning an input electrical signal for producing an output signal characteristic of a signal which has passed through such an umbilical.

14. The apparatus according to claim 13, comprising a DC-AC converter for conditioning the input electrical signal.

15. The apparatus according to claim 14, wherein the converter conditions the input electrical signal using pulse width modulation.

16. The apparatus according to claim 14, wherein the DC-AC converter comprises an H-bridge.

17. The apparatus according to claim 16, wherein the H-bridge comprises a plurality of switches, the operation timings of the switches being controlled by the programmed processing unit to effect the conditioning.

18. The apparatus according to claim 17, wherein the switch timings are selected by the processing unit from a look-up table.

19. The apparatus according to claim 18, wherein the processing unit stores a plurality of look-up tables relating to respective input signal frequencies.

20. The apparatus according to claim 13, comprising a converter configured to convert an input AC electrical signal to DC prior to conditioning.
